(19) United States
(12) Patent Application Publication
(10) Pub. No.: US 2025/0350949 A1
(43) Pub. Date: Nov. 13, 2025

(54) APPARATUS AND METHOD FOR SECURITY EVENT MONITORING IN A WIRELESS COMMUNICATIONS SYSTEM

(71) Applicant: Lenovo (Singapore) Pte. Ltd., New Tech Park (SG)

(72) Inventors: Sheeba Backia Mary Baskaran, Friedrichsdorf (DE); Roozbeh Atarius, La Jolla, CA (US); Andreas Kunz, Ladenburg (DE)

(21) Appl. No.: 18/660,697

(22) Filed: May 10, 2024

(51) Int. Cl. H04W 12/122; H04L 9/40; H04W 4/60

(52) U.S. Cl. CPC H04W 12/122; H04L 63/1408; H04W 4/60

(57) ABSTRACT

Various aspects of the present disclosure relate to methods, apparatuses, and devices for wireless communication. A network function may receive a security monitoring assistance subscription request. The network function may also determine a security monitoring policy based on the security monitoring assistance subscription request. The network function may transmit a security event exposure subscription request based on the security monitoring policy.

### TECHNICAL FIELD

The present disclosure relates to wireless communications, and more specifically to security event monitoring in a wireless communications system.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Various aspects of the present disclosure relate to wireless communications, including improved methods and apparatuses for security event monitoring in a wireless communications system. A network function may receive a security monitoring assistance subscription request. The network function may also determine a security monitoring policy based on the security monitoring assistance subscription request. The network function may transmit a security event exposure subscription request based on the security monitoring policy.

### BRIEF DESCRIPTION OF THE DRAWINGS

FIG. 1 illustrates an example of a wireless communications system in accordance with aspects of the present disclosure.

FIG. 2 illustrates a flow diagram of communications in a wireless system that enable security monitoring during a normal active phase of a network equipment (NE) in accordance with aspects of the present disclosure.

FIG. 3 illustrates a flow diagram of communications in a wireless system that collect data and construct a secure data transparent container at a data source in accordance with aspects of the present disclosure.

FIG. 4 illustrates a flow diagram of communications in a wireless system that collect data at various data sources and construct a secure data transparent container for the collected data at an aggregation point in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a NE in accordance with aspects of the present disclosure.

FIG. 8 illustrates a flowchart of a method performed by a NE in accordance with aspects of the present disclosure.

FIG. 9 illustrates a flowchart of another method performed by an NE in accordance with aspects of the present disclosure.

### DETAILED DESCRIPTION

Various aspects of the present disclosure relate to improved methods and apparatuses for security event monitoring in a wireless communications system. Certain systems may not be able to collect some event data in a wireless communications system, such as abnormal event data, thereby causing security breach or attack attempts. Collecting and handling data from abnormal events may reduce power consumption, reduce security risk, reduce processor usage, reduce data usage, increase overall system security, and increase overall system performance.

Aspects of the present disclosure are described in the context of a wireless communications system.

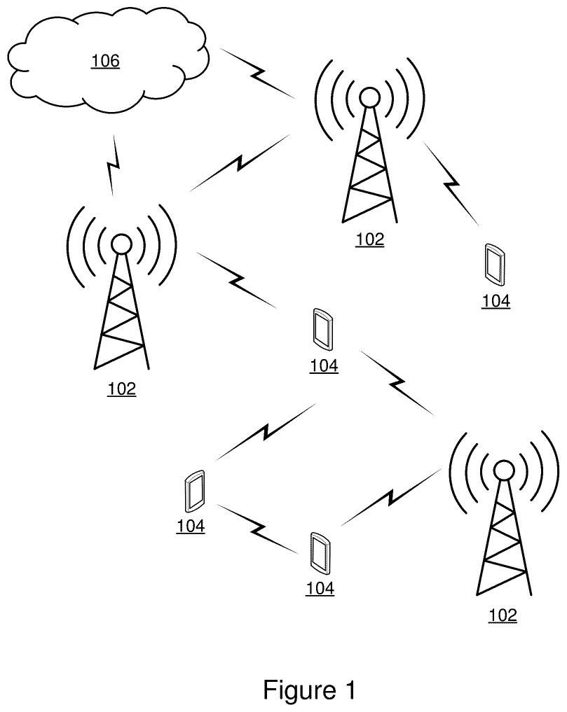

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In certain 5G systems, a network data analytics function (NWDAF) may be capable of collecting general data (e.g., related to network performance, load, UE mobility, etc.,) for analytics and predictions generation process, but the NWDAF may not be capable of processing abnormal event data (e.g., due to a critical security breach or attack attempts). As 5G-advanced systems may be expected to support data collection of abnormal event related information for exposure to a security function to enable security evaluation and monitoring (e.g., for threat and/or attack detections), without proper mechanisms in place, the NWDAF, if used to collect data, may lead to security breaches and/or impacts at the NWDAF.

Security evaluation and monitoring of 5G systems may use abnormal event related information and/or data (e.g., malformed messages, massive number of service invocations due to flooding attack attempts, repeated authentication and/or authorization failure, abnormal service based interface (SBI) flow (e.g., for the call of a service based architecture (SBA)), unallowed transport layer security (TLS) connection setup, and so forth) to be collected from various entities such as network functions (NFs), radio access network (RAN) nodes, and UEs. The collected abnormal events related information may include security logs or a data set with actual malformed messages (e.g., malicious remote execution codes) sent by abnormally behaving entities or NFs, massive service invocation related data for denial-of-service attempt, authentication and/or authorization failure data with certificate information and so forth, where the event data may also include respective key performance indicators (KPIs), and metrics (e.g., number of times the event occurred information etc.). The collected abnormal event data may be processed by designated security functions (e.g., security evaluation and/or monitoring function (e.g., security information and event management (SIEM), security orchestration, automation, and response (SOAR) tools) as these functions are capable of processing collected sensitive event data without any compromise to itself). Because an improper processing of the collected event data or security log containing malformed messages (e.g., malicious remote execution codes and/or links or a virus) may cause a security breach to a processing healthy network function.

A 5G system may include heterogeneous and varied NF deployments, where security mechanisms may determine service access among NFs by authentication (e.g., identifier and credentials based) and authorization. If any NF runs into errors (e.g., due to configuration issues) or behaves maliciously (e.g., due to insider threats and/or privilege misuse or cyber-attacks), then such NF behavior information or related threat assessments may not be considered in current security mechanisms (e.g., for any service access). Some zero trust tenets (e.g., tenets 5,7) may provide motivation that resource access (e.g., access control to network services) may be evaluated while also taking into account the dynamic policies that are defined and enforced related to security monitoring (e.g., threat assessments) and continuous trust evaluation (e.g., according to evaluation factors and may include an observable state of a requestor, characteristics, behavioral attributes (e.g., subject analytics, measured deviations from the observed usage patterns), environmental attributes (e.g., location, time, reported attacks), security posture, and so forth).

Some systems may identify relevant factors for data collection that may enhance security monitoring and mitigate against insider attacks. If any NF that has been deployed in a core network becomes compromised or starts to behave maliciously, and remains undetected then the NF may be misused in attacks leading to a service failure, data loss and/or theft, and so forth. A 5GS may provide the means to facilitate collection of data potentially relevant for operator-based security evaluation and monitoring.

Moreover, various data may be collected and exposed to an external function (e.g., operator's security evaluation and monitoring entity which is outside a 3GPP domain, such as a SIEM). The data that needs to be collected related to NFs for security monitoring may include information on any violation of normal behavior observed in an NF (e.g., an evaluation target). The collected data, such as malicious behaviors and/or activity, may need to go through security evaluation to enable an overall security monitoring process.

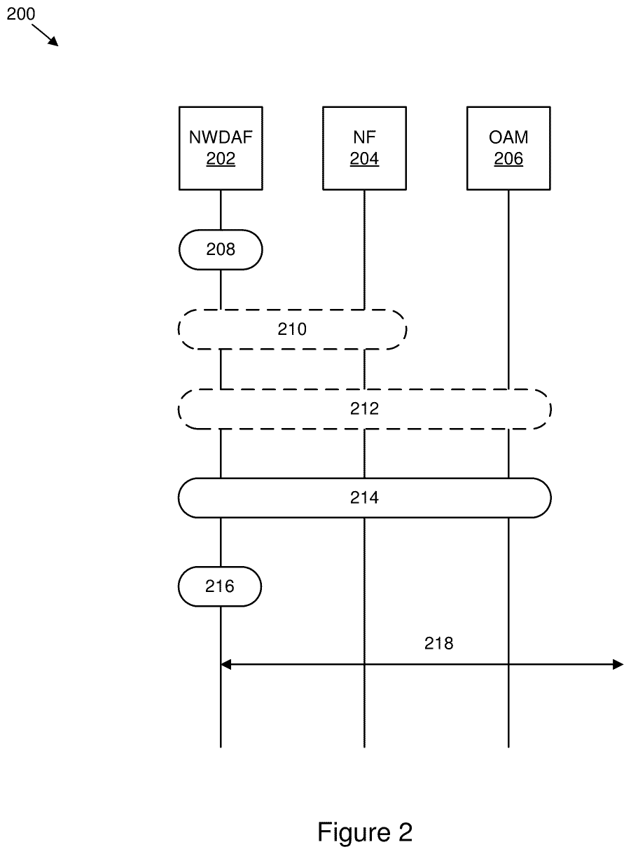

Malicious behavior related data may be identified relative to various events such as predefined service operation violations (e.g., malformed messages), unintended configuration changes, message requests exceeding configured limits, and current resource utilization information (e.g., if it exceeds resource utilization limits) which may be collected as inference data in the form of security logs or reports from the evaluation targets indirectly via an operations, administration, and maintenance (OAM). For malicious behavior related data, indirect data collection from evaluation targets via the OAM to limit the impact (e.g., over the existing event exposure services) by reusing and leveraging an OAM data collection procedure. Data collection and exposure to enable security evaluation for monitoring is shown in FIG. 2.

FIG. 2 illustrates a flow diagram 200 of communications in a wireless system that enable security monitoring during a normal active phase of a NE in accordance with aspects of the present disclosure. The flow diagram 200 includes communications between an NWDAF 202, an NF 204, and an OAM 206. Each communication may include one or more messages.

At 208, the NWDAF 202 based on operator local policy may collect the data and provide to the external operator function to enable (e.g., assist) security evaluation and monitoring.

At 210 and 212, the NWDAF 202 may collect data related to the NF 204 load and resource utilization by using data collection procedures related to NF load (e.g., collection from a network repository function (NRF)) and NF resource usage (e.g., collection from the OAM 206).

At 214, the NWDAF 202 may use management service from the OAM 206 to collect inference data related to various malicious behaviors specific to event identifiers for one or more evaluation target NFs. For OAM 206 based data collection, the NWDAF 202 may collect input data specific to the evaluation target NFs identification information and target event identifiers. The OAM 206 may collect the inference data (e.g., as a form of security logs and/or reports) from the target evaluation NFs based on the events indicated and, at 216, may provide the collected inference data to the NWDAF 202.

At 218, the NWDAF 202 may act as a proxy and may provide the collected data to an external operator managed function (e.g., to enable security evaluation and monitoring) via an NEF.

It should be noted that an external operator function and/or entity, algorithm, or intelligence used for the evaluation and/or security analysis may be up to an operator's implementation. Further, the interface used between the NWDAF 202 to NEF and NEF to AF (e.g., the external operator function is up to the normative work (e.g., it can be similar to the interface between NEF and external AF or may be same as an N6 interface)). For NEF service exposure to AF, existing NEF services may be reused with adaptations.

In FIG. 2, without proper mechanisms in place, the NWDAF 202, if used to collect data, may process the collected event data containing malicious attack information which may lead to security breach and/lor impacts at the NWDAF 202.

Different embodiments found herein may describe how abnormal and/or malicious behavior event data can be collected and provided (e.g., in a transparent container to be transparent to the other intermediate entities and/or functions such as NWDAF) to a security function to let the security function do security monitoring (e.g., security evaluation and monitoring to identify the threats and/or attacks attempts based on processing and evaluation of the collected data and intelligence such as using artificial intelligence (AI) and/or machine learning (ML) logic).

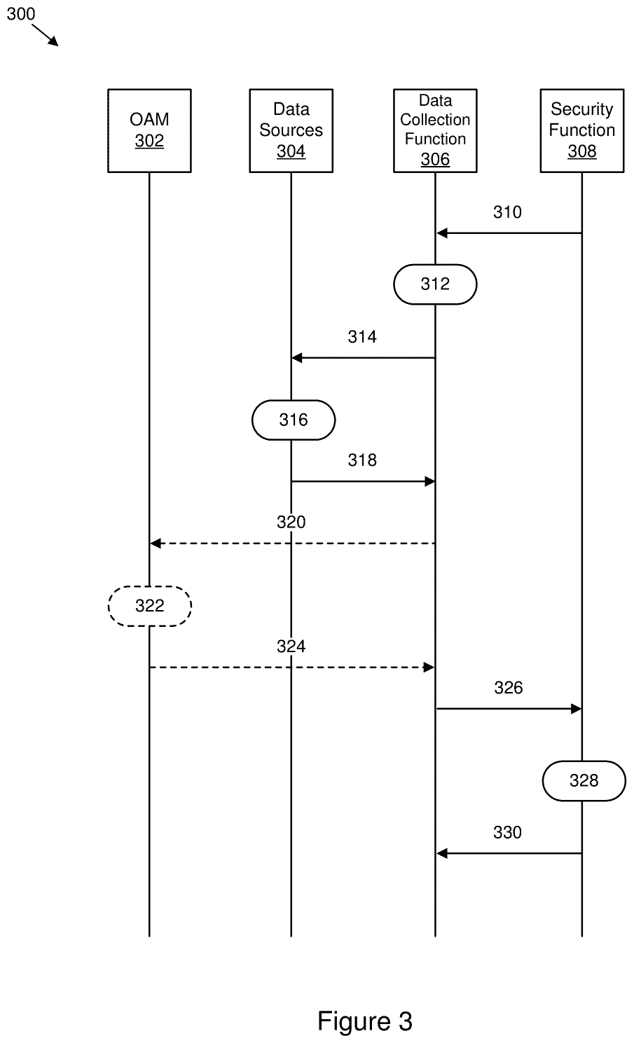

In a first embodiment, there may be a method to construct a security data transparent container at a data source and provide and/or expose data for security monitoring. The first embodiment describes how potential data to identify security risks, threats, and/or attack attempts can be collected from a data source (or data producers) transparently by an intermediate network function (e.g., such as a NF, NWDAF, a security proxy, a data collection function and/or data aggregation function) to be provided to a network function, application function, and/or entity such as a security function (e.g., for processing of the received data to perform security evaluations and monitoring) as shown in FIG. 3. The potential data may include information related to the events and/or security events such as reception of malformed messages, reception of massive number of service application protocol interface (API) invocations (or excess message and service load), authentication failure (e.g., repeated), authorization failure (e.g., repeated) (or authorization token and/or claims failure or invalid token access), unexpected, unallowed, unintended, and/or undesired TLS connection establishment (e.g., unintended operation event (e.g., TLS session and API invocation related to reconnaissance)), abnormal message flow violating allowed network deployment and/or topology (e.g., abnormal SBI call flow event), and so forth.

FIG. 3 illustrates a flow diagram 300 of communications in a wireless system that collect data and construct a secure data transparent container at a data source in accordance with aspects of the present disclosure. The flow diagram 300 includes communications between an OAM 302, data sources 304 (e.g., NFs, NRFs, service communication proxy (SCP)), a NWDAF 306 (e.g., data collection function, security proxy), and a security function 308. Each communication may include one or more messages.

A NF in the network (e.g., 5G system) can perform the data collection from various data sources (e.g., NFs/AFs, radio nodes/entities, UEs which experiences events related to abnormal behaviors or malicious behaviors/messages, e.g., service requests/responses, data request/responses, notifications, and so forth) to enable security evaluation and monitoring. The NF which performs the data collection from various data sources to enable security evaluation and monitoring may be a logical function called as security proxy/security data aggregation function/trust or security evaluation enabler function/NWDAF 306, which may either be a standalone function or may be co-located with the NWDAF 306 or may be a service (e.g., security monitoring assistance service) offered by the NWDAF 306 itself. In the first embodiment, the NF is referred to as NWDAF 306 or data collection function. The NWDAF 306 may offer a security monitoring assistance service.

Another function in the first embodiment performs processing of received collected data to perform security evaluation and monitoring (e.g., performs security threat/attack detection) and is referred as the security function 308. The security function 308 may be internal or external to a 3GPP network, but may be located in the operator's network.

At 310, the security function 308 may subscribe to the security monitoring assistance service offered by the NWDAF 306. The security function 308 may send to the NWDAF 306 a security monitoring assistance service_subscribe request message with list of event IDs (for which NWDAF 306 should assist for data collection), the network identifier (e.g., may indicate any one or more of public land mobile network (PLMN) identifier (ID), non-public network (NPN) ID/standalone NPN (SNPN) ID, public network integrated NPN (PNINPN) ID), and target network type (e.g., may indicate one or more of core network, SBA network/interface, non-SBA network/interface, radio network, UEs, relay nodes, and so forth).

When needed, the security function 308 may unsubscribe from the security monitoring assistance service offered by the NWDAF 306. Moreover, the security monitoring assistance service offered by the security events data collection NF/NWDAF 306 may be called a security evaluation and monitoring assistance service. Further, a ‘Target network type’ information element (IE) may be called a ‘target monitoring entity’ or ‘monitoring target in a network’ IE.

At 312, the NWDAF 306 manages an operator's security monitoring policy e.g., it may include one or more event IDs specific to different abnormal behaviors (each event ID may be related to events/security events such as reception of malformed messages, reception of massive number of service API invocations (or excess-message and service load), (repeated) authentication failure, (repeated) authorization failure (or authorization token/claims failure or invalid token access), unexpected/unallowed/unintended/undesired TLS connection establishment (e.g., unintended operation event (e.g., TLS session and API invocation related to reconnaissance), abnormal message flow violating allowed network deployment/topology (e.g., abnormal SBI call flow event) etc.,) for which data collection (e.g., security logs/report along with KPIs or metrics specific to each event occurrence) and exposure to the security function is allowed or permitted in the network. The NWDAF 306, based on operator's security monitoring policy and/or event IDs listed in the subscribe request from security function 308, may determine to collect event ID specific data from the data sources 304. The data sources 304 from which the data needs to be collected may be determined based on one or more of the following such as the network identifier (e.g., PLMN ID, NPN ID/SNPN ID, PNINPN ID) and target network type (e.g., may indicate one or more of a core network, SBA network/interface, non-SBA network/interface, radio network, UEs, relay nodes, etc.). Additionally, an operator local policy or security monitoring policy may indicate NF types (e.g., AMF/SMF/UPF/AUSF/NRF/NWDAF/UDM/UDR/PCF/LMF), which may be considered a data source for abnormal behavior/security events related data collection.

If a network identifier is used to determine the data source for the data collection, then all functions and entities belonging to the respective network indicated with ‘network identifier’ may be considered as a data source to subscribe to event exposure and collect data for abnormal behavior related events as requested in the event IDs and allowed and/or permitted by the operator's security monitoring policy.

Additionally, if a target network type is used to determine the data source for the data collection, then all functions and entities belonging to the respective network type indicated with ‘network type’ may be considered as data source to subscribe to event exposure and collect data for abnormal behavior related events as requested in the event IDs and allowed/permitted by the operator's security monitoring policy. The event ID may be referred to as security event IDs as they indicate an event/security event whose data will be used to perform security evaluation and monitoring.

In some systems, the operator's security monitoring policy may include list data source IDs (e.g., NF IDs, AF IDs, RAN IDs, gNB IDs, UE ID) that are considered to belong to less reliable/untrusted/less security/vulnerable locations/infrastructures, where these data source IDs if configured or available in the operator's security monitoring policy, the event/security event related data collection is initiated from such data sources (e.g., event exposure services is subscribed to collect the data from those data sources for the security event IDs).

In one example, the NWDAF 306 may have an implicit subscription for the security function to provide/expose event data related to the security event IDs specific to the events described in this embodiment.

At 314, the NWDAF 306 sends event exposure subscribe request to the data source 304 (such as NFs/AFs including SCPs, NRFs if that target network type is SBA or core network or UEs which the network type is UEs, or RAN nodes if the network type is radio network, relay nodes if the network type is relay node), with event IDs, security monitoring activate induction and reporting mode (e.g., event driven/periodic with some interval time).

The NWDAF 306 may send an event exposure subscribe request to the data source 304 such as NFs/AFs/SCP (e.g., to certain type of NFs based on the target network type received at 310).

If the ‘Target network type’ IE (e.g., ‘target monitoring entity’ or ‘monitoring target in the network’ IE) indicates SBA/core network or RAN nodes or UE (e.g., if the data need to be collected for security evaluation and monitoring or if data need to be collected for security events), the NWDAF 306 sends a security/malicious behavior/abnormal event exposure subscribe request to the data source 304 with security event IDs, and/or security monitoring activate induction and reporting mode (e.g., event driven/periodic with some interval time). If needed, at any time the NWDAF 306 may unsubscribe to events IDs from the data source 304 by using a security/malicious behavior/abnormal event exposure unsubscribe request message.

At 316, the data source 304 (e.g., NF/AFs/SCP/RAN node/relay node/UEs) based on the received security monitoring activation indication, determines to log/record (e.g., for all the indicated event ID(s)) the related abnormal events related information (e.g., actual messages related to the event IDs, KPI/metrics such as a number of times the event occurs, etc.), time of the event occurrence, source address/ID that triggered the event or performed/attempted the event (e.g., who behaves maliciously or abnormally with the data source to identify the origination of the event, services or message names related to the event, etc.), and activates the event ID based data collection. If the subscribed event occurs, it collects the event data along with event KPIs/metrics (e.g., as security logs/reports), constructs a security data transparent container using the event data (e.g., security logs/reports), an example security data transparent container is shown in Table 1. The security data transparent container is constructed by the data source 304 (e.g., data collection points in the network such as NF/AF, RAN node, UE) to provide the collected event data/logs for security evaluation and monitoring purpose. For example, the KPI or metrics related to the abnormal event information may be a number of times of reception of malformed messages, a number of times or duration of reception of massive number of service API invocations, a number of times (repeated) of an authentication failure, a number of times (repeated) of an authorization failure (or authorization token/claims failure or invalid token access), a number of times unexpected/unallowed/unintended/undesired TLS connection establishment attempted, a number of times an abnormal message flow violating allowed network deployment/topology, and so forth.

TABLE 1
Security Data Transparent Container

Security Data Transparent Container IEI
Length of Security Data Transparent Container Contents
Data Source Identifier (e.g., NF ID/NF Instance ID), Data Source Type
(e.g., NF type), Data source Network ID (e.g., PLMN ID/NPN
ID/PNINPN ID),
Timestamp, Security Event ID(s), Security Event Data log, Related
kpis or metrics such as number of times each event occurred.
NOTE: Security event data log can include event origination/source
Identifier (e.g., NF ID/NF Instance ID), event origination/source
Type (e.g., NF type), where the event origination/source refers to
the entities or functions which attempted the abnormal
behavior(s)/events/security events.

At 318, the data source 304 sends (e.g., NF/AFs/SCP/RAN node/relay node/UEs) sends the event exposure notify message to the NWDAF 306 respective to the subscribed and occurred event IDs which includes the security data transparent container. The data source 304 may send the security/malicious behavior/abnormal event exposure notify message to the NWDAF 306 respective to the subscribed and occurred security event IDs, which includes the security data transparent container. It should be noted that step 318 may be sent immediately when an event is occurred if the reporting mode indicates ‘event driven’ in 314, or step 318 may be sent when a time interval is passed to do a periodic reporting if the reporting mode indicates ‘periodic with some time instance stated’ in 314. Moreover, steps 314, 316, and 318 happen when the NWDAF 306 collects the abnormal behavior related data from the data source 304 by means of direct data collection.

In some examples, steps 320, 322, and 324 may happen when the NWDAF 306 collects abnormal behavior related data from the data source via the OAM 302 by means of indirect data collection.

At 320, the NWDAF 306 sends an event exposure subscribe request to the OAM 302 to collect abnormal behavior related data from the data source (e.g., such as NFs/AFs including SCPs, NRFs if that target network type is SBA or core network or UEs which the network type if UEs, or RAN nodes if the network type is radio network, relay nodes if the network type is relay node), with event IDs, target data source (e.g., which includes network identifier and target network type information), and/or security monitoring activate induction and reporting mode (e.g., event driven/periodic with some interval time).

The NWDAF 306 may send an event exposure subscribe request to the OAM 302 for the data sources such as NFs/AFs/SCP (e.g., to certain type of NFs based on the target network type). In some examples, the service message name used in step 320 may be termed as a security/malicious behavior/abnormal event exposure subscribe request.

At 322, the OAM 302 configures the appropriate data source (e.g., NF/AFs/SCP/RAN node/relay node/UEs) based on the received security monitoring activation indication, determines and configures to log/record for all the indicated event ID(s), the related abnormal events related information (e.g., actual messages related to the event IDs, KPI/metrics such as a number of times the event occurs, a time of the event occurrence, a source address/ID that triggered the event or initiated to identify the origination of the event, services or message names related to the event, and so forth), and activates event ID based data collection. If the subscribed event occurs, the data source, with the help of the OAM 302, collects the event data along with event KPIs/metrics (e.g., as security logs/reports), constructs a security data transparent container using the event data (e.g., security logs/reports). An example security data transparent container is shown in Table 1.

At 324, the OAM 302 on behalf of data source (e.g., NF/AFs/SCP/RAN node/relay node/UEs) sends the event exposure notify message to the NWDAF 306 respective to the subscribed and occurred event IDs, which includes the security data transparent container (e.g., constructed in step 322 as exemplified in Table 1). In some examples, the service message name used in step 324 may be a security/malicious behavior/abnormal event exposure notify message.

If needed any time, the NWDAF 306 may unsubscribe to events IDs from the OAM 302 using the security/malicious behavior/abnormal event exposure unsubscribe request message.

At 326, the NWDAF 306 sends a security monitoring assistance service notify message to the security function 308 which includes the security data transparent container. The security data container received and provided to the security function 308 is transparent to the NWDAF 306 and the NWDAF 306 doesn't process the information received in the security data transparent container, instead the NWDAF 306 just collects the data as part of the security data transparent container, and it is forwarded to the security function 308. The security monitoring assistance notify service operation message may be called a security evaluation and monitoring assistance notify service operation message.

At 328, the security function 308 processes the data received in the security data transparent container and performs attack/threat detection (e.g., if any security threat exists) based on the received data as part of the security evaluations and monitoring.

At 330, the security function 308 sends a security monitoring assistance service_acknowledgement (ack) message which may include the security evaluation and monitoring results. The security evaluation and monitoring results may be sent back to NWDAF to any other network function (e.g., PCF/NRF or NF in the network) and/or OAM designated to perform further actions based on the obtained results to improve the security (i.e., to take actions over the compromised NFs/entities) in the network. One example result may be in the form: (attack likelihood or security severity/attack severity/threat severity: any of 0/1 (e.g., a Boolean value) or 1-100%, attack category/type: active/passive/not applicable, attack source ID (e.g., related to the event origination/source ID), attack source network type (e.g., related to the event origination/source network type), attack source network ID (e.g., related to the event origination/source network ID such PLMN ID/NPN ID/PNINPN ID to which the attack originator belong to), attack/threat id/name: No attack/Not applicable, configuration issues, DOS/DDOS/MiTM/Remote execution/Privilege escalation/Poisoning/Hijack/Injection/broken user authentication, broken object level authorization, broken function level authorization, service-side request forgery, authentication hijacking, broken access control, insufficient rate limiting, flooding etc.).

The event ID may be referred to as a security event ID as it indicates an event/security event whose data may be used to perform security evaluation and monitoring. The message in step 330 may be called a security evaluation and monitoring assistance service_response/acknowledgement (ack) message.

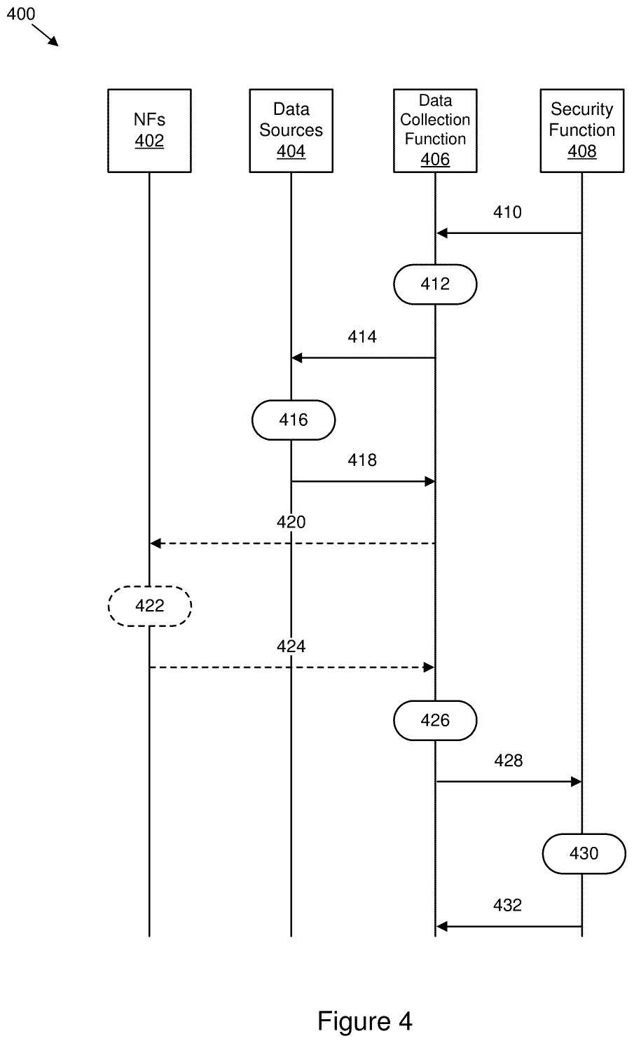

In a second embodiment, there may be a method to construct a security data transparent container at a data collection point and provide/expose security monitoring. Specifically, the second embodiment describes how potential data to identify security risk/threat/attack attempts may be collected from the data sources by an intermediate network function (e.g., such as a NF/NWDAF/a security proxy or data aggregation function) to be aggregated and combined (e.g., as a secure data transparent container) and provided to a network function such as security function (e.g., for processing of the received data to perform security evaluations and monitoring) as shown in FIG. 4. The potential data may include information related to events such as reception of malformed messages, reception of massive number of service API invocations (or excess-message and service load), (repeated) authentication failure, (repeated) authorization failure (or authorization token/claims failure or invalid token access), unexpected/unallowed/unintended/undesired TLS connection establishment (e.g., unintended Operation event (e.g., TLS session and API invocation related to reconnaissance)), abnormal message flow violating allowed network deployment/topology (e.g., abnormal SBI call flow event) etc.).

FIG. 4 illustrates a flow diagram 400 of communications in a wireless system that collect data at various data sources and construct a secure data transparent container for the collected data at an aggregation point in accordance with aspects of the present disclosure. The flow diagram 400 includes communications between NFs 402, data sources 404 (e.g., NFs, NRFs, SCP), a NWDAF 406 (e.g., data collection function, NF, security proxy), and a security function 406. Each communication may include one or more messages.

A NF in the network (e.g., 5G system) may perform the data collection from various data sources (e.g., NFs/AFs, Radio nodes/entities, UEs which experiences events related to abnormal behaviors or malicious behaviors/messages such as service requests/responses, data request/responses, notifications, and so forth) to enable security monitoring. The NF which performs the data collection from various data sources to enable security monitoring may be a logical function called as security proxy/security data aggregation function/trust or security evaluation enabler function/NWDAF, which may either be a standalone function or may be co-located with NWDAF or may be a service (e.g., security monitoring assistance service) offered by the NWDAF 406 itself. In this embodiment, the NF may be referred to as the NWDAF 406 in the following steps for simplicity. The NWDAF 406 may offer security monitoring assistance service.

Another function in the first embodiment performs processing of received collected data to perform security evaluation and monitoring (e.g., performs security threat/attack detection) and is referred as the security function 408. The security function 408 may be external/internal to a 3GPP network, but may be located in the operator's network.

At 410, the security function 408 may subscribe to the security monitoring assistance service offered by the NWDAF 406. The security function 408 may send to the NWDAF 406 a security monitoring assistance service_subscribe request message with list of event IDs (for which NWDAF 306 should assist for data collection), the network identifier (e.g., may indicate any one or more of PLMN ID, NPN ID/SNPN ID, PNINPN ID), and target network type (e.g., may indicate one or more of core network, SBA network/interface, non-SBA network/interface, radio network, UEs, relay nodes, and so forth).

When needed, the security function 408 may unsubscribe from the security monitoring assistance service offered by the NWDAF 406. Moreover, the security monitoring assistance service offered by the security events data collection NF/NWDAF 406 may be called a security evaluation and monitoring assistance service. Further, a ‘Target network type’ IE may be called a ‘target monitoring entity’ or ‘monitoring target in a network’ IE.

At 412, the NWDAF 406 manages an operator's security monitoring policy e.g., it may include one or more event IDs specific to different abnormal behaviors (each event ID may be related to events/security events such as reception of malformed messages, reception of massive number of service API invocations (or excess-message and service load), (repeated) authentication failure, (repeated) authorization failure (or authorization token/claims failure or invalid token access), unexpected/unallowed/unintended/undesired TLS connection establishment (e.g., unintended operation event (e.g., TLS session and API invocation related to reconnaissance), abnormal message flow violating allowed network deployment/topology (e.g., abnormal SBI call flow event) etc.,) for which data collection (e.g., security logs/report along with KPIs or metrics specific to each event occurrence) and exposure to the security function is allowed or permitted in the network. The NWDAF 406, based on operator's security monitoring policy and/or event IDs listed in the subscribe request from security function 408, may determine to collect event ID specific data from the data sources 404. The data sources 404 from which the data needs to be collected may be determined based on one or more of the following such as the network identifier (e.g., PLMN ID, NPN ID/SNPN ID, PNINPN ID) and target network type (e.g., may indicate one or more of a core network, SBA network/interface, non-SBA network/interface, radio network, UEs, relay nodes, etc.). Additionally, an operator local policy or security monitoring policy may indicate NF types (e.g., AMF/SMF/UPF/AUSF/NRF/NWDAF/UDM/UDR/PCF/LMF), which may be considered a data source for abnormal behavior/security events related data collection.

If a network identifier is used to determine the data source for the data collection, then all functions and entities belonging to the respective network indicated with ‘network identifier’ may be considered as a data source to subscribe to event exposure and collect data for abnormal behavior related events as requested in the event IDs and allowed and/or permitted by the operator's security monitoring policy.

Additionally, if a target network type is used to determine the data source for the data collection, then all functions and entities belonging to the respective network type indicated with ‘network type’ may be considered as data source to subscribe to event exposure and collect data for abnormal behavior related events as requested in the event IDs and allowed/permitted by the operator's security monitoring policy. The event ID may be referred to as security event IDs as they indicate an event/security event whose data will be used to perform security evaluation and monitoring.

In some systems, the operator's security monitoring policy may include list data source IDs (e.g., NF IDs, AF IDs, RAN IDs, gNB IDs, UE ID) that are considered to belong to less reliable/untrusted/less security/vulnerable locations/infrastructures, where these data source IDs if configured or available in the operator's security monitoring policy, the event/security event related data collection is initiated from such data sources (e.g., event exposure services is subscribed to collect the data from those data sources for the security event IDs).

In one example, the NWDAF 406 may have an implicit subscription for the security function to provide/expose event data related to the security event IDs specific to the events described in this embodiment.

At 414, the NWDAF 406 sends event exposure subscribe request to the data source 404 (such as NFs/AFs including SCPs, NRFs if that target network type is SBA or core network or UEs which the network type is UEs, or RAN nodes if the network type is radio network, relay nodes if the network type is relay node), with event IDs, security monitoring activate induction and reporting mode (e.g., event driven/periodic with some interval time).

The NWDAF 406 may send an event exposure subscribe request to the data source 404 such as NFs/AFs/SCP (e.g., to certain type of NFs based on the target network type received at 410).

If the ‘Target network type’ IE (e.g., ‘target monitoring entity’ or ‘monitoring target in the network’ IE) indicates SBA/core network or RAN nodes or UE (e.g., if the data need to be collected for security evaluation and monitoring or if data need to be collected for security events), the NWDAF 406 sends a security/malicious behavior/abnormal event exposure subscribe request to the data source 404 with security event IDs, and/or security monitoring activate induction and reporting mode (e.g., event driven/periodic with some interval time). If needed, at any time the NWDAF 406 may unsubscribe to events IDs from the data source 404 by using a security/malicious behavior/abnormal event exposure unsubscribe request message.

At 416, the data source 404 (e.g., NF/AFs/SCP/RAN node/relay node/UEs) based on the received security monitoring activation indication, determines to log/record (e.g., for all the indicated event ID(s)) the related abnormal events related information (e.g., actual messages related to the event IDs, KPI/metrics such as a number of times the event occurs, etc.), time of the event occurrence, source address/ID that triggered the event or performed/attempted the event (e.g., who behaves maliciously or abnormally with the data source to identify the origination of the event, services or message names related to the event, etc.), and activates the event ID based data collection. If the subscribed event occurs, it collects the event data along with event KPIs/metrics (e.g., as security logs/reports) based on the subscribed events IDs and occurred events. For example, the KPI or metrics related to the abnormal event information may be a number of times of reception of malformed messages, a number of times or duration of reception of massive number of service API invocations, a number of times (repeated) of an authentication failure, a number of times (repeated) of an authorization failure (or authorization token/claims failure or invalid token access), a number of times unexpected/unallowed/unintended/undesired TLS connection establishment attempted, a number of times an abnormal message flow violating allowed network deployment/topology, and so forth.

At 418, the data source 404 sends (e.g., NF/AFs/SCP/RAN node/relay node/UEs) sends the event exposure notify message to the NWDAF 406 respective to the subscribed and occurred event IDs which includes the security logs/reports or data source identifier, data source type (e.g., NF type), data source PLMN ID/NPN ID/PNINPN ID, timestamp, security event IDs, related kpis or metrics such as number of times each security event occurred, security event log, and so forth.

The data source 404 may send the security/malicious behavior/abnormal event exposure notify message to the NWDAF 406 respective to the subscribed and occurred security event IDs, which includes the event data/event information as security logs/reports.

It should be noted that step 418 may be sent immediately when an event is occurred if the reporting mode indicates ‘event driven’ in 414, or step 418 may be sent when a time interval is passed to do a periodic reporting if the reporting mode indicates ‘periodic with some time instance stated’ in 414. Moreover, steps 414, 416, and 418 happen when the NWDAF 406 collects the abnormal behavior related data from the data source 404 by means of direct data collection.

In some examples, steps 420, 422, and 424 may happen when the NWDAF 306 collects abnormal behavior related data from the data source via the NFs 402 by means of indirect data collection.

At 420, the NWDAF 406 sends an event exposure subscribe request to the NFs 402 to collect abnormal behavior related data from the data source (e.g., such as NFs/AFs including SCPs, NRFs if that target network type is SBA or core network or UEs which the network type if UEs, or RAN nodes if the network type is radio network, relay nodes if the network type is relay node), with event IDs, target data source (e.g., which includes network identifier and target network type information), and/or security monitoring activate induction and reporting mode (e.g., event driven/periodic with some interval time).

The NWDAF 406 may send an event exposure subscribe request to the NFs 402 for the data sources such as NFs/AFs/SCP (e.g., to certain type of NFs based on the target network type).

At 422, the NFs 402 configure the appropriate data source (e.g., NF/AFs/SCP/RAN node/relay node/UEs) based on the received security monitoring activation indication, determines and configures to log/record for all the indicated event ID(s), the related abnormal events related information (e.g., actual messages related to the event IDs, KPI/metrics such as a number of times the event occurs, a time of the event occurrence, a source address/ID that triggered the event or initiated to identify the origination of the event, services or message names related to the event, and so forth), and activates event ID based data collection. If the subscribed event occurs, the data source, with the help of the NFs 402, collects the event data along with event KPIs/metrics (e.g., as security logs/reports) based on the subscribed events IDs and occurred events.

At 424, the NFs 402 on behalf of data source (e.g., NF/AFs/SCP/RAN node/relay node/UEs) send the event exposure notify message to the NWDAF 406 respective to the subscribed and occurred event IDs, which includes the security logs/reports (e.g., same as described in step 418).

At 426, the NWDAF 406 constructs a security data transparent container using the event data (e.g., security logs/reports) received from one or more data sources, some examples of security data transparent container construction are shown in Tables 2 and 3. The security data transparent container is constructed by data collection/aggregation points in the network such as the NWDAF 406 to provide the collected and combined data/logs for security evaluation and monitoring purposes.

At 428, the NWDAF 406 sends a security monitoring assistance service notify message to the security function 408 which includes the security data transparent container. The security data container constructed and provided to the security function 408 is considered transparent to the NWDAF 406 and the NWDAF 406 doesn't process the information received inside the security logs/reports, instead the NWDAF 406 just collects the data as part of the security logs, and it is aggregated and forwarded to the security function as part of a security data transparent container.

TABLE 2
(Option 1a): security data transparent container with aggregated
security logs/reports from various data sources

Security Data Transparent Container IEI
Length of Security Data Transparent Container Contents
List of Data Sources [DS1, DS2, DS3, . . . DSn]
Security Data (i.e., Security event information/security event data collected from
different data sources)
Data Source Identifier, Data Source Type (e.g., NF type), Data source PLMN ID/NPN
ID/PNINPN ID, Timestamp, Security Event IDs, Related kpis or metrics such as
number of times each security event occurred, Security Event log 1
Data Source Identifier, Data Source Type (e.g., NF type), Data source PLMN ID/NPN
ID/PNINPN ID, Timestamp, Security Event IDs, Related kpis or metrics such as
number of times each security event occurred, Security Event log 2
Data Source Identifier, Data Source Type (e.g., NF type), Data source PLMN ID/NPN
ID/PNINPN ID, Timestamp, Security Event IDs, Related kpis or metrics such as
number of times each security event occurred, Security Event log 3
. . .
Data Source Identifier, Data Source Type (e.g., NF type), Data source PLMN ID/NPN
ID/PNINPN ID, Timestamp, Security Event IDs, Related kpis or metrics such as
number of times each security event occurred, Security Event log n

TABLE 3
(Option 1b): security data transparent container with aggregated
security logs/reports from various data sources.

Security Data Transparent Container IEI
Length of Security Data Transparent Container Contents
Security Data (i.e., Security event information/security event data collected from
different data sources)
Data Source 1:
Data Source Identifier, Data Source Type (e.g., NF type), Data source PLMN ID/NPN
ID/PNINPN ID, Timestamp (when security log received), Security Event IDs,
Related kpis or metrics such as number of times each security event occurred,
Security Event log 1
Data Source 2:
Data Source Identifier, Data Source Type (e.g., NF type), Data source PLMN ID/NPN
ID/PNINPN ID, Timestamp (when security log received), Security Event IDs,
Related kpis or metrics such as number of times each security event occurred,
Security Event log 2
Data Source 3:
Data Source Identifier, Data Source Type (e.g., NF type), Data source PLMN ID/NPN
ID/PNINPN ID, Timestamp (when security log received), Security Event IDs,
Related kpis or metrics such as number of times each security event occurred,
Security Event log 3
. . .
Data Source n:
Data Source Identifier, Data Source Type (e.g., NF type), Data source PLMN ID/NPN
ID/PNINPN ID, Timestamp (when security log received), Security Event IDs,
Related kpis or metrics such as number of times each security event occurred,
Security Event log n

The security monitoring assistance notify service operation message may be called a security evaluation and monitoring assistance notify service operation message.

At 430, the security function 408 processes the data received in the security data transparent container and performs attack/threat detection (e.g., if any security threat exists) based on the received data as part of the security evaluations and monitoring.

At 432, the security function 408 sends a security monitoring assistance service_acknowledgement (ack) message which may include the security evaluation and monitoring results. The security evaluation and monitoring results may be sent back to NWDAF to any other network function (e.g., PCF/NRF or NF in the network) and/or OAM designated to perform further actions based on the obtained results to improve the security (i.e., to take actions over the compromised NFs/entities) in the network. One example result may be in the form: (attack likelihood or security severity/attack severity/threat severity: any of 0/1 or 1-100%, attack category/type: active/passive/not applicable, attack source ID (e.g., related to the event origination/source ID), attack source network type (e.g., related to the event origination/source network type), attack source network ID (e.g., related to the event origination/source network ID such PLMN ID/NPN ID/PNINPN ID to which the attack originator belong to), attack/threat id/name: No attack/Not applicable, configuration issues, DOS/DDOS/MiTM/Remote execution/Privilege escalation/Poisoning/Hijack/Injection/broken user authentication, broken object level authorization, broken function level authorization, service-side request forgery, authentication hijacking, broken access control, insufficient rate limiting, flooding etc.).

The event ID may be referred to as a security event ID as it indicates an event/security event whose data may be used to perform security evaluation and monitoring. The message in step 432 may be called a security evaluation and monitoring assistance service_response/acknowledgement (ack) message. It should be noted that step 432 may include one or more attack results related to each of the data collected from different data sources.

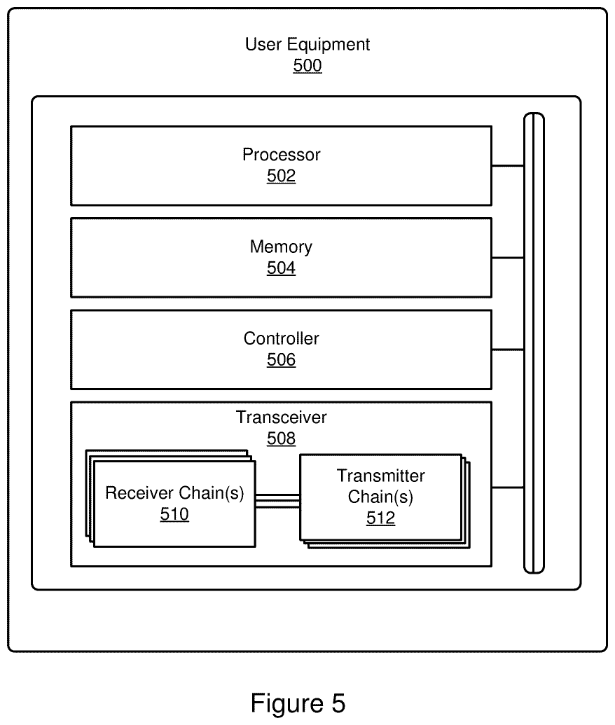

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. For example, the processor 502 coupled with the memory 504 may be configured to cause the UE 500 to perform actions as described herein.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

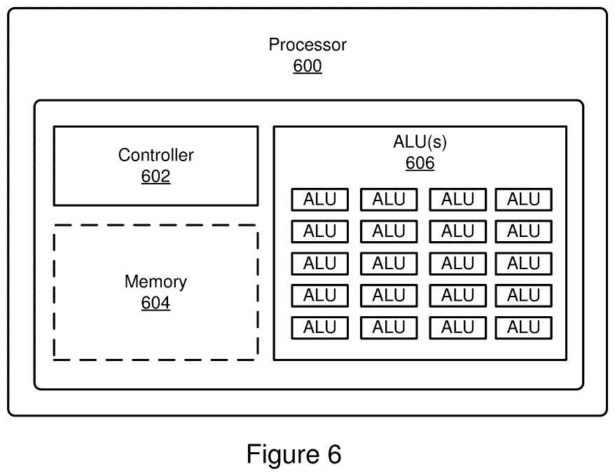

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for: performing functions as described herein.

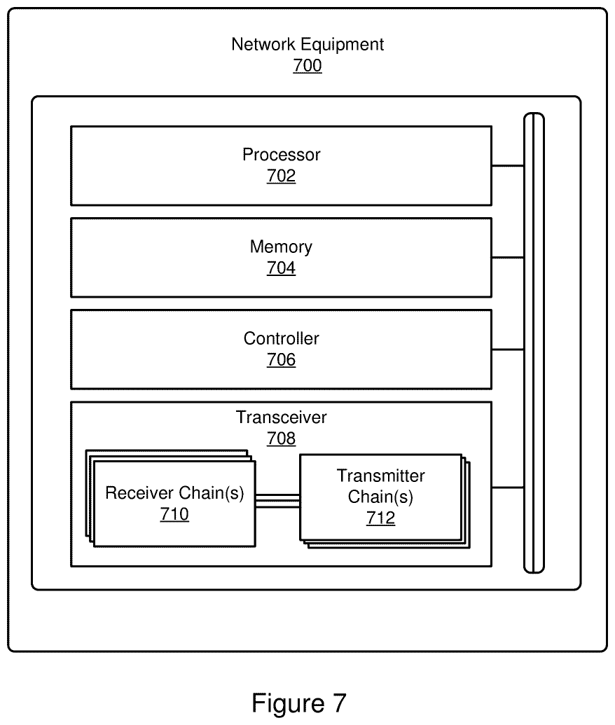

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure. For example, the processor 702 coupled with the memory 704 may be configured to cause the NE 700 to: receive a security monitoring assistance subscription request, determine a security monitoring policy based on the security monitoring assistance subscription request, and transmit a security event exposure subscription request based on the security monitoring policy. As another example, the processor 702 coupled with the memory 704 may be configured to cause the NE 700 to: receive a security event exposure subscription request based on a security monitoring policy, collect security event data from a plurality of data sources in response to a subscribed security event occurring, and transmit a response to the security event exposure subscription request based on the security event data collected.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

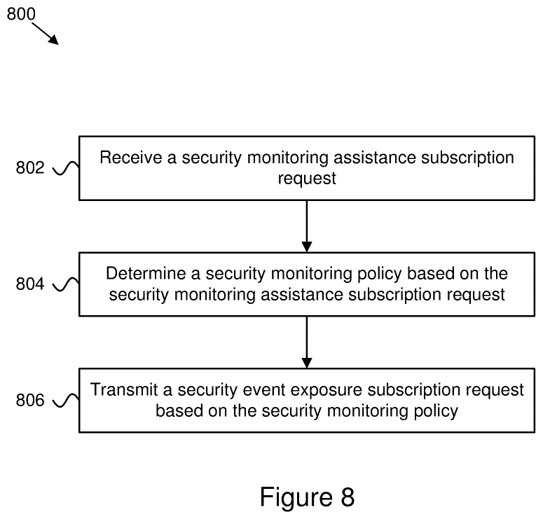

FIG. 8 illustrates a flowchart of a method 800 in accordance with aspects of the present disclosure. The operations of the method 800 may be implemented by a NE as described herein. In some implementations, a NE 700 may execute a set of instructions to control the function elements of a processor to perform the described functions.

At 802, the method may include receiving a security monitoring assistance subscription request. The operations of 802 may be performed in accordance with examples as described herein. In some implementations, aspects of the operations of 802 may be performed by a NE as described with reference to FIG. 7.

At 804, the method may include determining a security monitoring policy based on the security monitoring assistance subscription request. The operations of 804 may be performed in accordance with examples as described herein. In some implementations, aspects of the operations of 804 may be performed by a NE as described with reference to FIG. 7.

At 806, the method may include transmitting a security event exposure subscription request based on the security monitoring policy. The operations of 806 may be performed in accordance with examples as described herein. In some implementations, aspects of the operations of 806 may be performed by a NE as described with reference to FIG. 7.

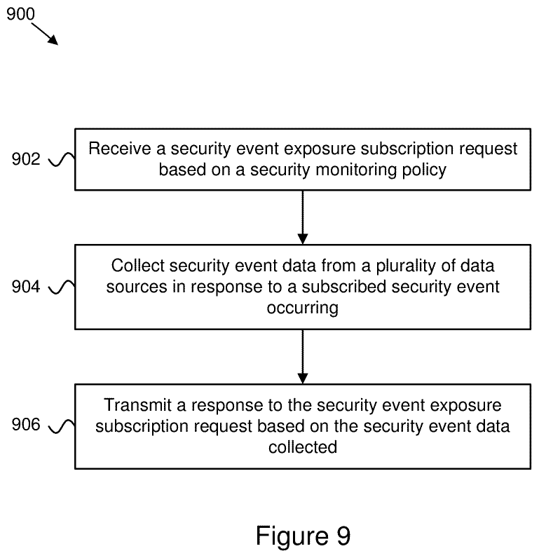

FIG. 9 illustrates a flowchart of another method 900 in accordance with aspects of the present disclosure. The operations of the method 900 may be implemented by a NE as described herein. In some implementations, a NE 700 may execute a set of instructions to control the function elements of a processor to perform the described functions.

At 902, the method may include receiving a security event exposure subscription request based on a security monitoring policy. The operations of 902 may be performed in accordance with examples as described herein. In some implementations, aspects of the operations of 902 may be performed by a NE as described with reference to FIG. 7.

At 904, the method may include collecting security event data from a plurality of data sources in response to a subscribed security event occurring. The operations of 904 may be performed in accordance with examples as described herein. In some implementations, aspects of the operations of 904 may be performed by a NE as described with reference to FIG. 7.

At 906, the method may include transmitting a response to the security event exposure subscription request based on the security event data collected. The operations of 906 may be performed in accordance with examples as described herein. In some implementations, aspects of the operations of 906 may be performed by a NE as described with reference to FIG. 7.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for performing a network function, the apparatus comprising:
at least one memory; and
at least one processor coupled with the at least one memory and configured to cause the apparatus to:
receive a security monitoring assistance subscription request;
determine a security monitoring policy based on the security monitoring assistance subscription request; and
transmit a security event exposure subscription request based on the security monitoring policy.

2. The apparatus of claim 1, wherein the at least one processor is configured to cause the apparatus to receive a response to the security event exposure subscription request.

3. The apparatus of claim 2, wherein the response to the event exposure subscription request comprises a security data container, security event information, a time stamp, metrics about a number of times each security event occurred, security logs, or a combination thereof.

4. The apparatus of claim 2, wherein the at least one processor is configured to cause the apparatus to determine a security data container based on security event data received from a plurality of data sources.

5. The apparatus of claim 1, wherein the at least one processor is configured to cause the apparatus to transmit a response to the security monitoring assistance subscription request.

6. The apparatus of claim 4, wherein the response to the security monitoring assistance subscription request comprises a security data container.

7. The apparatus of claim 1, wherein the security monitoring assistance subscription request comprises a security event identifier, a network identifier, a target security monitoring network type, or a combination thereof.

8. The apparatus of claim 1, wherein the security monitoring policy comprises a plurality of events to be used for data collection.

9. The apparatus of claim 1, wherein the security event exposure subscription request comprises a security monitoring activation indication, a reporting mode, or a combination thereof.

10. The apparatus of claim 1, wherein the network function comprises a data collection function.

11. The apparatus of claim 1, wherein the security monitoring assistance subscription request is received from a security function.

12. The apparatus of claim 1, wherein the security event exposure subscription request is transmitted to a data source, a data producer, or both.

13. A method for performing a network function, the method comprising:
receiving a security monitoring assistance subscription request;
determining a security monitoring policy based on the security monitoring assistance subscription request; and
transmitting a security event exposure subscription request based on the security monitoring policy.

14. An apparatus for performing a network function, the apparatus comprising:
at least one memory; and
at least one processor coupled with the at least one memory and configured to cause the apparatus to:
receive a security event exposure subscription request based on a security monitoring policy;
collect security event data from a plurality of data sources in response to a subscribed security event occurring; and
transmit a response to the security event exposure subscription request based on the security event data collected.

15. The apparatus of claim 14, wherein the response to the security event exposure subscription request comprises a security data container, event information, security logs, or a combination thereof.

16. The apparatus of claim 14, wherein the security monitoring policy comprises a plurality of security events to be used for data collection.

17. The apparatus of claim 14, wherein the security event exposure subscription request comprises a security monitoring activation indication, a reporting mode, or a combination thereof.

18. The apparatus of claim 14, wherein the at least one processor is configured to cause the apparatus to construct a security data container based on the security event data.

19. The apparatus of claim 14, wherein the at least one processor is configured to cause the apparatus to collect security event metrics, security event key performance indicators, security logs, a number of times each security event occurred, or some combination thereof.

20. A method for performing a network function, the method comprising:
receiving a security event exposure subscription request based on a security monitoring policy;
collecting security event data from a plurality of data sources in response to a subscribed security event occurring; and
transmitting a response to the security event exposure subscription request based on the security event data collected.
